(19) United States
(12) Patent Application Publication
(10) Pub. No.: US 2025/0140247 A1
(43) Pub. Date: May 1, 2025

(54) METHOD AND DEVICE FOR PERFORMING TEXT AND SPEECH TASK

(71) Applicant: 42dot Inc., Seoul (KR)

(72) Inventor: Shukjae CHOI, Seongnam-si (KR)

(73) Assignee: 42dot Inc., Seoul (KR)

(21) Appl. No.: 18/928,952

(22) Filed: Oct. 28, 2024

Related U.S. Application Data
(60) Provisional application No. 63/593,954, filed on Oct. 27, 2023.

(30) Foreign Application Priority Data
Oct. 28, 2024 (KR) 10-2024-0148346

(51) Int. Cl. G10L 15/183; G10L 13/027; G10L 15/06

(52) U.S. Cl. CPC G10L 15/183; G10L 13/027; G10L 15/063

(57) ABSTRACT

Provided are a method and device for performing text and speech tasks. A method for performing text and speech tasks, performed by a computing device including a processor and a storage medium, using a unified decoder-only model to execute multiple tasks related to text and speech, the method including: reading, by the processor, a unified vocabulary from the storage medium or an external storage medium connected via a network; reading, by the processor, information regarding a predetermined data format from the storage medium or the external storage medium; generating, by the processor, input for the unified decoder-only model according to the data format, using a token from the unified vocabulary and a predetermined special token; and providing, by the processor, the input to the unified decoder-only model to obtain inference results for the multiple tasks related to text and speech.

### CROSS-REFERENCE TO RELATED APPLICATION

This application claims priority to and the benefit of U.S. Provisional Patent Application No. 63/593,954 filed on Oct. 27, 2023 and Korean Patent Application No. 10-2024-0148346 filed on Oct. 28, 2024, the entire contents of which are incorporated herein by reference.

### BACKGROUND

### (a) Field

The present disclosure relates to a method and device for performing text and speech tasks.

### (b) Description of the Related Art

Traditionally, speech applications such as ASR (Automatic Speech Recognition) and TTS (Text-to-Speech) use an encoder-decoder architecture. The encoder-decoder architecture consists of an encoder for processing input and a decoder for generating output. For example, STT (Speech-to-Text) includes a speech encoder and a text decoder, while TTS uses a text encoder and a speech decoder. In such an architecture, integrating encoder-decoder components for task-specific and modality-specific purposes to merge various tasks is highly complex.

### SUMMARY

The present disclosure attempts to provide a method and device for performing text and speech tasks, which can handle multiple speech tasks through a single model with improved generalization performance based on multitask learning by integrating various speech-related tasks into one generative language model.

According to an embodiment, provided is a method for performing text and speech tasks, performed by a computing device including a processor and a storage medium, using a unified decoder-only model to execute multiple tasks related to text and speech, the method including: reading, by the processor, a unified vocabulary from the storage medium or an external storage medium connected via a network; reading, by the processor, information regarding a predetermined data format from the storage medium or the external storage medium; generating, by the processor, input for the unified decoder-only model according to the data format, using a token from the unified vocabulary and a predetermined special token; and providing, by the processor, the input to the unified decoder-only model to obtain inference results for the multiple tasks related to text and speech.

The unified vocabulary may be generated by merging a speech token and a text token.

The special token may be designated to guide the unified decoder-only model in performing the multiple tasks related to text and speech.

The data format may be specified such that the special token and a token belonging to the unified vocabulary are alternately connected.

The special token may include: a first special token indicating the beginning of the text; a second special token indicating the beginning of the speech; a third special token instructing the unified decoder-only model to generate the text; and a fourth special token instructing the unified decoder-only model to generate the speech.

The multiple tasks related to text and speech may include: a first task related to STT (speech-to-text) for speech recognition; a second task related to TTS (text-to-speech) for speech synthesis; a third task related to TTT (text-to-text) for text generation; and a fourth task related to STS (speech-to-speech) for speech generation.

The generating input for the unified decoder-only model may include: generating, by the processor, the input to include the second special token, a speech token from the unified vocabulary, and the third special token to guide the unified decoder-only model in performing the first task.

The generating input for the unified decoder-only model may include: generating, by the processor, the input to include the first special token, a text token from the unified vocabulary, and the fourth special token to guide the unified decoder-only model in performing the second task.

The generating input for the unified decoder-only model may include: generating, by the processor, the input to include the third special token and a token from the unified vocabulary to guide the unified decoder-only model in performing the third task.

The generating input for the unified decoder-only model may include: generating, by the processor, the input to include the fourth special token and a speech token from the unified vocabulary to guide the unified decoder-only model in performing the fourth task.

The method may further include training, by the processor, the unified decoder-only model to perform the first task, wherein the training is performed based on training data that includes the second special token, a speech token from the unified vocabulary, the third special token, and a text token from the unified vocabulary.

The method may further include training, by the processor, the unified decoder-only model to perform the second task, wherein the training is performed based on training data that includes the first special token, a text token from the unified vocabulary, the fourth special token, and a speech token from the unified vocabulary.

The method may further include training, by the processor, the unified decoder-only model to perform the third task, wherein the training is performed based on training data that includes the third special token and a text token from the unified vocabulary.

The method may further include training, by the processor, the unified decoder-only model to perform the fourth task, wherein the training is performed based on training data that includes the fourth special token and a speech token from the unified vocabulary.

According to another embodiment, provided is a device for performing text and speech tasks using a unified decoder-only model, the device executing program code loaded into one or more memory devices through one or more processors to perform multiple tasks related to text and speech, wherein the program code, when executed, performs the following: reading a unified vocabulary from the memory device, storage medium, or an external storage medium connected via a network; reading information regarding a predetermined data format from the memory device, the storage medium, or the external storage medium; generating input for the unified decoder-only model according to the data format, using a token from the unified vocabulary and a predetermined special token; and providing the input to the unified decoder-only model to obtain inference results related to the multiple text and speech tasks.

The unified vocabulary may be generated by merging a speech token and a text token.

The special token may be designated to guide the unified decoder-only model in performing the multiple tasks related to text and speech.

The special token may include: a first special token indicating the beginning of the text; a second special token indicating the beginning of the speech; a third special token instructing the unified decoder-only model to generate the text; and a fourth special token instructing the unified decoder-only model to generate the speech.

The multiple tasks related to text and speech may include: a first task related to STT (speech-to-text) for speech recognition; a second task related to TTS (text-to-speech) for speech synthesis; a third task related to TTT (text-to-text) for text generation; and a fourth task related to STS (speech-to-speech) for speech generation, and the generating input for the unified decoder-only model may include generating the input to include at least one of the first to fourth special tokens and a text token or a speech token from the unified vocabulary to guide the unified decoder-only model in performing any one of the first to fourth tasks.

### BRIEF DESCRIPTION OF THE DRAWINGS

FIG. 1 is a block diagram for explaining a device for performing text and speech tasks according to an embodiment.

FIGS. 2 to 4 are diagrams for explaining implementation examples of a device for performing text and speech tasks according to an embodiment.

FIG. 5 is a flowchart for explaining a method for performing text and speech tasks according to an embodiment.

FIG. 6 is a flowchart for explaining a method for performing text and speech tasks according to an embodiment.

FIG. 7 is a flowchart for explaining a method for performing text and speech tasks according to an embodiment.

FIG. 8 is a diagram for explaining a computing device according to an embodiment.

### DETAILED DESCRIPTION

Hereinafter, embodiments of the present disclosure are described in detail with reference to the accompanying drawings so that those skilled in the art to which the present disclosure pertains may easily practice the present disclosure. However, the present disclosure may be implemented in various different forms and is not limited to the embodiments described herein. In addition, in the drawings, portions unrelated to the description are omitted to clearly describe the present disclosure, and similar portions are denoted by similar reference numerals throughout the specification.

Through the specification and claims, unless explicitly described otherwise, “including” any components will be understood to imply the inclusion of another component rather than the exclusion of another component. Terms including ordinal numbers such as “first”, “second”, and the like, may be used to describe various components. However, these components are not limited by these terms. These terms are used only to distinguish one component and another component from each other.

Terms such as “˜part”, “˜er/or”, and “module” described in the specification may refer to a unit capable of processing at least one function or operation described in the specification, which may be implemented as hardware, a circuit, software, or a combination of hardware or circuit and software. In addition, at least some components or functions of a method and device for performing text and speech tasks according to the embodiments described below may be implemented as a program or software, and the program or software may be stored in a computer-readable medium.

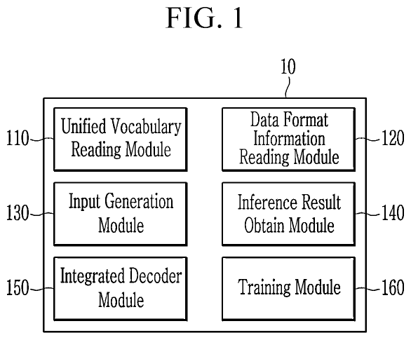

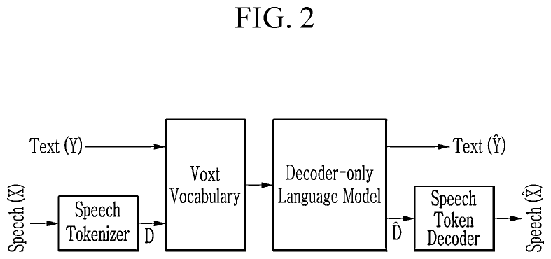

FIG. 1 is a block diagram for explaining a device for performing text and speech tasks according to an embodiment, and FIGS. 2 to 4 are diagrams for explaining implementation examples of a device for performing text and speech tasks according to an embodiment.

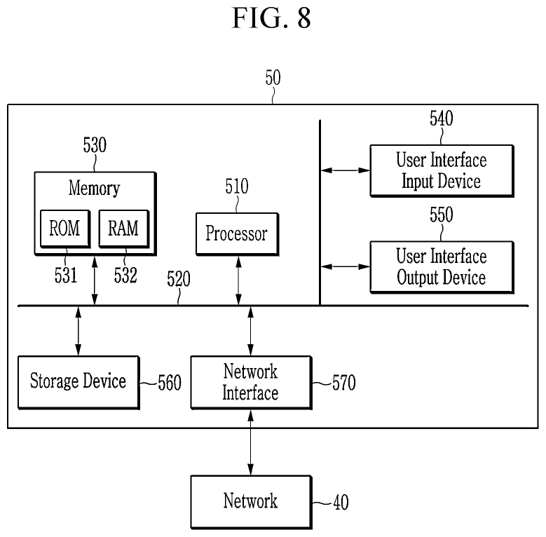

Referring to FIG. 1, a device 10 for performing text and speech tasks according to an embodiment may execute program code or instructions loaded into one or more memory devices through one or more processors. For example, the device 10 for performing text and speech tasks may be implemented as a computing device 50, as will be described later in relation to FIG. 8. In this case, the one or more processors correspond to the processor 510 of the computing device 50, and the one or more memory devices correspond to the memory 520 of the computing device 50. The program code or instructions may be executed by the one or more processors to perform multiple text and speech-related tasks using an integrated decoder model. In this specification, the term “module” is used to logically distinguish functions performed by the program code or instructions.

The device 10 for performing text and speech tasks may process multiple speech tasks, i.e., multiple text and speech-related tasks, within a single autoregressive decoder model. The decoder-only model may, for example, use only the decoder part of a transformer structure. The decoder model converts input into tokens, processes those tokens, and may generate the next word in a sequence. Here, the autoregressive method may involve predicting the current token, then using that token for the next prediction, progressively generating the entire sequence. In the autoregressive model, the process of predicting the next token may be defined probabilistically, where the probability of each token may be conditionally determined by the tokens that precede it.

The device 10 for performing text and speech tasks may include all or at least some of the following: a unified vocabulary reading module 110, a data format information reading module 120, an input generation module 130, an inference result obtain module 140, an integrated decoder model 150, and a training module 160. For example, the training module 160 may be implemented within the device 10 for performing text and speech tasks. Alternatively, for instance, the training module 160 may be implemented externally to the device 10 for performing text and speech tasks, and the device 10 for performing text and speech tasks may receive the trained integrated decoder model 150 from the training module 160.

The unified vocabulary reading module 110 may read the unified vocabulary. For example, the device 10 for performing text and speech tasks may be implemented as a computing device 50 that includes a processor and a storage medium. The processor may read the unified vocabulary from a storage medium within the computing device 50 or from an external storage medium connected via a network to the computing device 50.

The unified vocabulary may be generated by merging speech tokens and text tokens. For example, assuming Y=(yᵢ∈Vₜₓₜ|i=1, . . . , tₜₓₜ) represents a text utterance of length tₜₓₜ in vocabulary Vₜₓₜ, the probability of Y may be expressed as p(Y)=Πᵢ₌₁^{t_txt} p(yᵢ|y₁, . . . , yᵢ₋₁) (where t_txt is the same as tₜₓₜ). When processing continuous speech signals, they may be converted into discrete speech tokens using a tokenizer, represented as D=(dᵢ∈V_{dst}|i=1, . . . , t_{dst}), where V_{dst} may be the vocabulary of discrete speech tokens. These discrete speech tokens may be treated as spoken language within Vast and modeled in a similar way to text. Speech and text may be combined into a new vocabulary, i.e., Vₒₓₜ vocabulary, by Vᵥₒₓₜ=Vₜₓₜ∪V_{dst}. Accordingly, the probabilities of the speech and text tokens may be modeled as Z, where Z=(zᵢ∈V|i=1, . . . , t). This probability may be expressed as p (Z)=Πᵢ₌₁^{t}p(zᵢ|z₁, . . . , zᵢ₋₁). Here, Z may represent discrete speech tokens D(V=V_{dst}), text tokens Y(V=Vₜₓₜ), or various combinations of Y and D.

Referring to FIG. 2, the input to the decoder-only language model may be speech and text from the Vᵥₒₓₜ vocabulary. To process speech, two additional modules may be used, enabling conversion between the continuous and discrete domains in speech. A speech tokenizer may map speech X to D, and a speech token decoder may convert the generated D\hat{ } back to speech X\hat{ }.

In some embodiments, the speech tokenizer may use k-means clustering to derive discrete features from the pre-trained HuBERT. Here, the k value may be selected to effectively capture linguistic information while adequately representing other acoustic aspects that are particularly important for speech synthesis.

In some embodiments, subword modeling may be applied within the Vᵥₒₓₜ vocabulary to replace frequently occurring patterns with metatokens. Through subword modeling, more contextual information may be included in the text, or the sequence length of the speech may be reduced.

The data format information reading module 120 may read information regarding a predetermined data format. For example, the device 10 for performing text and speech tasks may be implemented as a computing device 50 that includes a processor and a storage medium. The processor may read information regarding the predetermined data format from a storage medium within the computing device 50 or from an external storage medium connected via a network to the computing device 50. Here, the data format may be used when generating input for the integrated decoder model 150.

The input generation module 130 may generate input for the integrated decoder model 150 using tokens belonging to the unified vocabulary and predetermined special tokens. Additionally, the input may be generated to comply with the data format read by the data format information reading module 120. For example, the device 10 for performing text and speech tasks may be implemented as a computing device 50 that includes a processor and a storage medium. The processor may generate input for the integrated decoder model 150, following the data format, by using tokens from the unified vocabulary and predetermined special tokens.

The special tokens may be designated to guide the integrated decoder model 150 in performing multiple text and speech-related tasks. For example, the special tokens may include a first special token to a fourth special token. The first special token indicates the beginning of the text and may be implemented as a token such as “<start-text>.” The second special token indicates the beginning of the speech and may be implemented as a token such as “<start-speech>.” Meanwhile, the third special token instructs the integrated decoder model 150 to generate text and may be implemented as a token such as “<generate-text>.” The fourth special token instructs the integrated decoder model 150 to generate speech and may be implemented as a token such as “<generate-speech>.”

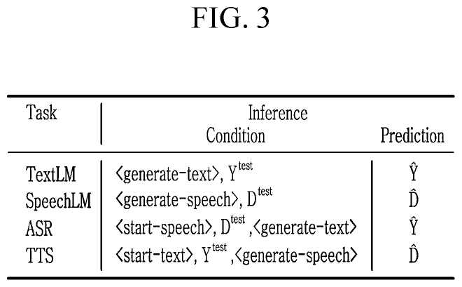

Referring to FIG. 3, FIG. 3 illustrates examples of data formats for various tasks during the inference process. As shown, in some embodiments, the data format may be specified such that special tokens and tokens belonging to the unified vocabulary are alternately connected to each other.

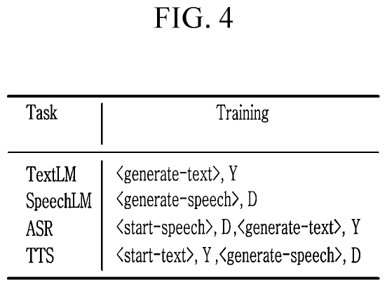

For example, the multiple text and speech-related tasks may include a first task to a fourth task. The first task may be related to STT (speech-to-text) for speech recognition, and the second task may be related to TTS (text-to-speech) for speech synthesis. Meanwhile, the third task may be related to TTT (text-to-text) for text generation, and the fourth task may be related to STS (speech-to-speech) for speech generation. In FIG. 3 and FIG. 4, the first task is labeled as “ASR,” the second task as “TTS,” the third task as “TextLM,” and the fourth task as “SpeechLM.”

In some embodiments, the input generation module 130 may generate input that includes all the second special token (for example, “<start-speech>”), the speech token D^{test} from the unified vocabulary, and the third special token (for example, “<generate-text>”) to guide the integrated decoder model 150 in performing the first task. Meanwhile, in other embodiments, the input generation module 130 may generate input that includes all of the first special token (for example, “<start-text>”), the text token Y^{test} from the unified vocabulary, and the fourth special token (for example, “<generate-speech>”) to guide the integrated decoder model 150 in performing the second task.

In other embodiments, the input generation module 130 may generate input that includes both third special token (for example, “<generate-text>”) and the text token Y^{test} from the unified vocabulary to guide the integrated decoder model 150 in performing the third task. Meanwhile, in other embodiments, the input generation module 130 may generate input that includes both the fourth special token (for example, “<generate-speech>”) and the speech token D^{test} from the unified vocabulary to guide the integrated decoder model 150 in performing the fourth task.

The inference result obtain module 140 may provide the input generated by the input generation module 130 to the integrated decoder model 150, to obtain inference results related to multiple text and speech tasks. For example, the device 10 for performing text and speech tasks may be implemented as a computing device 50 that includes a processor and a storage medium. The processor may provide the input generated by the input generation module 130 to the integrated decoder model 150 to obtain inference results related to multiple text and speech tasks.

The training module 160 may train the integrated decoder model 150 so that it can perform multiple text and speech-related tasks.

Referring to FIG. 4, FIG. 4 illustrates examples of data formats for various tasks during the training process. As shown, in some embodiments, the data format may be specified such that special tokens and tokens belonging to the unified vocabulary are alternately connected to each other.

For example, the multiple text and speech-related tasks may include a first task to a fourth task. The first task may be related to STT (speech-to-text) for speech recognition, and the second task may be related to TTS (text-to-speech) for speech synthesis. Meanwhile, the third task may be related to TTT (text-to-text) for text generation, and the fourth task may be related to STS (speech-to-speech) for speech generation. In FIG. 3 and FIG. 4, the first task is labeled as “ASR,” the second task as “TTS,” the third task as “TextLM,” and the fourth task as “SpeechLM.”

In some embodiments, the training for the integrated decoder model 150 to perform the first task may be conducted based on training data that includes all the second special token (for example, “<start-speech>”), the speech token D from the unified vocabulary, the third special token (for example, “<generate-text>”), and the text token Y from the unified vocabulary. Meanwhile, in other embodiments, the training for the integrated decoder model 150 to perform the second task may be conducted based on training data that includes all the first special token (for example, “<start-text>”), the text token Y from the unified vocabulary, the fourth special token (for example, “<generate-speech>”), and the speech token D from the unified vocabulary.

In other embodiments, the training for the integrated decoder model 150 to perform the third task may be conducted based on training data that includes both the third special token (for example, “<generate-text>”) and the text token Y from the unified vocabulary. Meanwhile, in other embodiments, the training for the integrated decoder model 150 to perform the fourth task may be conducted based on training data that includes both the fourth special token (for example, “<generate-speech>”) and the speech token D from the unified vocabulary.

Of course, the scope of the present invention is not limited to the embodiments described in relation to FIG. 3 and FIG. 4. That is, the scope of the present invention includes every task involving a combination of two or more modalities, beyond the four tasks illustrated in FIG. 3 and FIG. 4. For example, a form in which a command is given via speech and a response is generated as text is not limited to the ASR task and may be, for instance, a question-and-answer task. In another example, a form in which a command is given via text and a response is generated as speech may also serve purposes other than the TTS task.

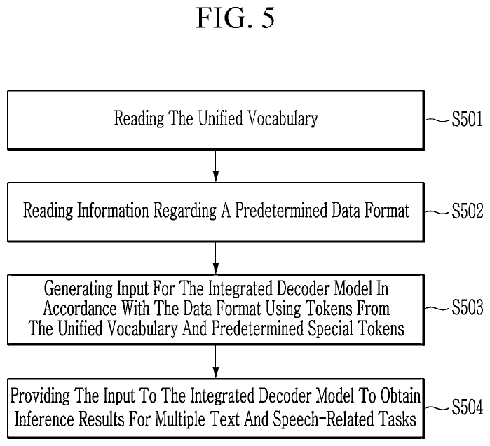

FIG. 5 is a flowchart for explaining a method for performing text and speech tasks according to an embodiment.

Referring to FIG. 5, a method for performing text and speech tasks according to an embodiment may include the following: reading the unified vocabulary (S501), reading information regarding a predetermined data format (S502), generating input for the integrated decoder model in accordance with the data format using tokens from the unified vocabulary and predetermined special tokens (S503), and providing the input to the integrated decoder model to obtain inference results for multiple text and speech-related tasks (S504).

For more detail regarding the above method, reference can be made to the descriptions of other embodiments provided in this specification. Therefore, redundant content is omitted here.

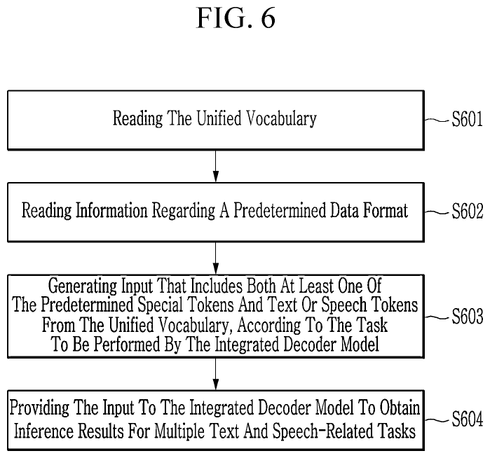

FIG. 6 is a flowchart for explaining a method for performing text and speech tasks according to an embodiment.

Referring to FIG. 6, a method for performing text and speech tasks according to an embodiment may include the following: reading the unified vocabulary (S601), reading information regarding a predetermined data format (S602), generating input that includes both at least one of the predetermined special tokens and text or speech tokens from the unified vocabulary, according to the task to be performed by the integrated decoder model (S603), and providing the input to the integrated decoder model to obtain inference results for multiple text and speech-related tasks (S604).

For more detail regarding the above method, reference can be made to the descriptions of other embodiments provided in this specification. Therefore, redundant content is omitted here.

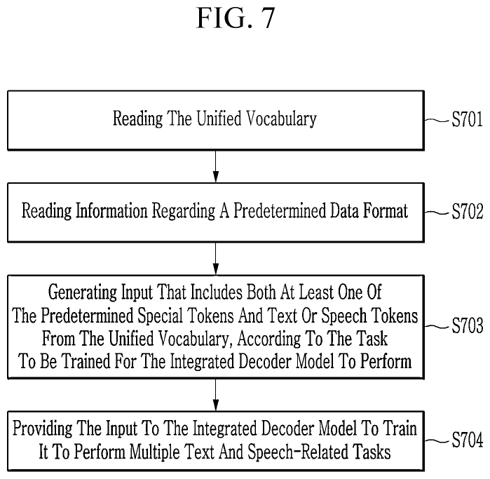

FIG. 7 is a flowchart for explaining a method for performing text and speech tasks according to an embodiment.

Referring to FIG. 7, a method for performing text and speech tasks according to an embodiment may include the following: reading the unified vocabulary (S701), reading information regarding a predetermined data format (S702), generating input that includes both at least one of the predetermined special tokens and text or speech tokens from the unified vocabulary, according to the task to be trained for the integrated decoder model to perform (S703), and providing the input to the integrated decoder model to train it to perform multiple text and speech-related tasks (S704).

For more detail regarding the above method, reference can be made to the descriptions of other embodiments provided in this specification. Therefore, redundant content is omitted here.

FIG. 8 is a diagram for explaining a computing device according to an embodiment.

Referring to FIG. 8, the method and device for performing text and speech tasks according to the embodiments may be implemented using a computing device 50. The computing device 50 may be implemented in various forms such as electronic devices, servers, or similar devices, and its functions may be realized through a combination of software and hardware.

The computing device 50 may include at least one of a processor 510, memory 530, user interface input device 540, user interface output device 550, and storage device 560, all of which communicate through a bus 520. The computing device 50 may also include a network interface 570, which is electrically connected to a network 40. The network interface 570 may transmit or receive signals to or from other entities through the network 40.

The processor 510 may be implemented as various types of computing units, such as an MCU (Micro Controller Unit), AP (Application Processor), CPU (Central Processing Unit), GPU (Graphic Processing Unit), NPU (Neural Processing Unit), or QPU (Quantum Processing Unit). The processor 510, as a semiconductor device that executes instructions stored in the memory 530 or storage device 560, may play a key role in the system. The program code and data stored in the memory 530 or storage device 560 instruct the processor 510 to perform specific tasks, enabling the overall operation of the system. Through this, the processor 510 may be configured to implement various functions and methods described earlier in relation to FIGS. 1 to 7.

The memory 530 and storage device 560 may include various types of volatile or non-volatile storage media for data storage and access in the system. For example, the memory 530 may include ROM (Read-Only Memory) 531 and RAM (Random Access Memory) 532. In some embodiments, the memory 530 may be embedded within the processor 510, allowing for very high data transfer speeds between the memory 530 and the processor 510. In other embodiments, the memory 530 may be located externally to the processor 510, and in this case, the memory 530 may be connected to the processor 510 via various data buses or interfaces. Such connections may be made using known methods, such as a PCIe (Peripheral Component Interconnect Express) interface or a memory controller for high-speed data transfer.

In some embodiments, at least a part of the configurations or functions of the method and device for performing text and speech tasks according to the embodiments may be implemented as a program or software executed on the computing device 50. The program or software may be stored in a computer-readable recording medium or storage medium. Specifically, a computer-readable recording medium or storage medium according to an embodiment may contain a program that, when executed by a processor 510 included in a computer, such as the memory 530 or storage device 560, performs the steps involved in the implementation of the method and device for performing text and speech tasks as described in the embodiments.

In some embodiments, at least a part of the configurations or functions of the method and device for performing text and speech tasks according to the embodiments may be implemented using hardware or circuitry of the computing device 50, or as separate hardware or circuitry that may be electrically connected to the computing device 50.

According to the embodiments, discrete speech tokens obtained from self-supervised speech features can be integrated with a text vocabulary and multitask learning can be performed using special tokens. Through such an integrated decoder model, all tasks, including speech recognition, speech synthesis, text generation, and speech continuation, can be performed using a single autoregressive decoder model.

Although the embodiments of the present disclosure have been described in detail hereinabove, the scope of the present disclosure is not limited thereto. That is, various modifications and alterations made by those skilled in the art to which the present disclosure pertains by using a basic concept of the present disclosure as defined in the following claims also fall within the scope of the present disclosure.

What is claimed is:

1. A method for performing text and speech tasks, performed by a computing device comprising a processor and a storage medium, using a unified decoder-only model to execute multiple tasks related to text and speech, the method comprising:
reading, by the processor, a unified vocabulary from the storage medium or an external storage medium connected via a network;
reading, by the processor, information regarding a predetermined data format from the storage medium or the external storage medium;
generating, by the processor, input for the unified decoder-only model according to the data format, using a token from the unified vocabulary and a predetermined special token; and
providing, by the processor, the input to the unified decoder-only model to obtain inference results for the multiple tasks related to text and speech.

2. The method of claim 1, wherein the unified vocabulary is generated by merging a speech token and a text token.

3. The method of claim 1, wherein the special token is designated to guide the unified decoder-only model in performing the multiple tasks related to text and speech.

4. The method of claim 1, wherein the data format is specified such that the special token and a token belonging to the unified vocabulary are alternately connected.

5. The method of claim 1, wherein the special token comprises:
a first special token indicating the beginning of the text;
a second special token indicating the beginning of the speech;
a third special token instructing the unified decoder-only model to generate the text; and
a fourth special token instructing the unified decoder-only model to generate the speech.

6. The method of claim 5, wherein the multiple tasks related to text and speech comprise:
a first task related to STT (speech-to-text) for speech recognition;
a second task related to TTS (text-to-speech) for speech synthesis;
a third task related to TTT (text-to-text) for text generation; and
a fourth task related to STS (speech-to-speech) for speech generation.

7. The method of claim 6, wherein the generating input for the unified decoder-only model comprises:
generating, by the processor, the input to include the second special token, a speech token from the unified vocabulary, and the third special token to guide the unified decoder-only model in performing the first task.

8. The method of claim 6, wherein the generating input for the unified decoder-only model comprises:
generating, by the processor, the input to include the first special token, a text token from the unified vocabulary, and the fourth special token to guide the unified decoder-only model in performing the second task.

9. The method of claim 6, wherein the generating input for the unified decoder-only model comprises:
generating, by the processor, the input to include the third special token and a token from the unified vocabulary to guide the unified decoder-only model in performing the third task.

10. The method of claim 6, wherein the generating input for the unified decoder-only model comprises:
generating, by the processor, the input to include the fourth special token and a speech token from the unified vocabulary to guide the unified decoder-only model in performing the fourth task.

11. The method of claim 6, further comprising training, by the processor, the unified decoder-only model to perform the first task,
wherein the training is performed based on training data that includes the second special token, a speech token from the unified vocabulary, the third special token, and a text token from the unified vocabulary.

12. The method of claim 6, further comprising training, by the processor, the unified decoder-only model to perform the second task,
wherein the training is performed based on training data that includes the first special token, a text token from the unified vocabulary, the fourth special token, and a speech token from the unified vocabulary.

13. The method of claim 6, further comprising training, by the processor, the unified decoder-only model to perform the third task,
wherein the training is performed based on training data that includes the third special token and a text token from the unified vocabulary.

14. The method of claim 6, further comprising training, by the processor, the unified decoder-only model to perform the fourth task,
wherein the training is performed based on training data that includes the fourth special token and a speech token from the unified vocabulary.

15. A device for performing text and speech tasks using a unified decoder-only model, the device executing program code loaded into one or more memory devices through one or more processors to perform multiple tasks related to text and speech, wherein the program code, when executed, performs the following:
reading a unified vocabulary from the memory device, storage medium, or an external storage medium connected via a network;
reading information regarding a predetermined data format from the memory device, the storage medium, or the external storage medium;
generating input for the unified decoder-only model according to the data format, using a token from the unified vocabulary and a predetermined special token; and
providing the input to the unified decoder-only model to obtain inference results related to the multiple text and speech tasks.

16. The device of claim 15, wherein the unified vocabulary is generated by merging a speech token and a text token.

17. The device of claim 15, wherein the special token is designated to guide the unified decoder-only model in performing the multiple tasks related to text and speech.

18. The device of claim 15, wherein the data format is specified such that the special token and the token belonging to the unified vocabulary are alternately connected.

19. The device of claim 15, wherein the special tokens comprises:
a first special token indicating the beginning of the text;
a second special token indicating the beginning of the speech;
a third special token instructing the unified decoder-only model to generate the text; and
a fourth special token instructing the unified decoder-only model to generate the speech.

20. The device of claim 19, wherein the multiple tasks related to text and speech comprises:
a first task related to STT (speech-to-text) for speech recognition;
a second task related to TTS (text-to-speech) for speech synthesis;
a third task related to TTT (text-to-text) for text generation; and
a fourth task related to STS (speech-to-speech) for speech generation, and
wherein the generating input for the unified decoder-only model comprises generating the input to include at least one of the first to fourth special tokens and a text token or a speech token from the unified vocabulary to guide the unified decoder-only model in performing any one of the first to fourth tasks.
